(19) United States
(12) Patent Application Publication
(10) Pub. No.: US 2013/0329936 A1
(43) Pub. Date: Dec. 12, 2013

(54) ARRAY SPEAKER STRUCTURE WITH POP-UP MECHANISMS

(71) Applicants: Chih-Wen Tseng, Taipei City (TW); Che-Ming Liang, Taipei City (TW); Jui-Hsiang Hsiao, Taipei City (TW)

(72) Inventors: Chih-Wen Tseng, Taipei City (TW); Che-Ming Liang, Taipei City (TW); Jui-Hsiang Hsiao, Taipei City (TW)

(21) Appl. No.: 13/491,010

(22) Filed: Jun. 7, 2012

(51) Int. Cl. H04R 1/02

(52) U.S. Cl. 381/387

(57) ABSTRACT

An array speaker structure with pop-up mechanisms includes: an array speaker unit; a first conductive connector positioned at an upper end of the array speaker unit; a second conductive connector positioned at a lower end of the array speaker unit, the array speaker unit being rotatably electrical-signal connected between the first and second conductive connectors; two pop-up mechanism installed in the first and second conductive connectors in electrical contact therewith; and a pushbutton switch for hooking or releasing the first conductive connector. When the pushbutton switch is moved away from the first conductive connector, the array speaker unit is bounced out under elastic restoring force of the pop-up mechanisms. Then the array speaker unit can be rotated to a desired position.

### BACKGROUND OF THE INVENTION

1. Field of the Invention

The present invention relates generally to an array speaker structure, and more particularly to an array speaker structure with pop-up mechanisms. The array speaker structure includes an array speaker unit, which can be bounced out under elastic restoring force of the pop-up mechanisms. Then the array speaker unit can be rotated to a desired position.

2. Description of the Related Art

It is known that tablet personal computer (shortened to tablet PC, tablet or slate) is a kind of miniaturized personal computer, which is convenient to carry. The tablet has a touch screen as a main input unit. The tablet is free from the conventional keyboard and mouse and allows a user to operate the touch screen in a handwritten or touch manner. In comparison with the current laptop, PDA and intelligent cellular phone, the tablet has the advantages of lightweight and larger screen and is obviously another convenient option of the consumers.

However, in consideration of miniaturization and convenient carriage, the convenient tablet often employs small-power speakers to accommodate the lightweight and slim design of the tablet. The small-power speakers can only emit sound at lower sound quality and volume. In the case that it is desired to enhance the audio effect, generally the tablet can be only connected to external speakers. This is totally not in conformity with the design object of the tablet.

In general, the speaker units of the loudspeaker system of the conventional tablet are fixedly disposed on left and right sides of the screen to provide left and right channels and create a stereo sound effect. However, as aforesaid, in consideration of miniaturization and convenient carriage, the convenient tablet often employs small-power speakers to accommodate the lightweight and slim design of the tablet. Therefore, the sound can be only emitted at lower sound quality and volume. In the case that it is desired to enhance the audio effect, generally the tablet can be only connected to external speakers. This is totally not in conformity with the design object of the tablet.

In addition, some tablets can provide portable digital audio/video entertainment function for a user. However, with the small-power speakers, the sound effect needs to be enhanced. In the case that the volume is turned up or the speakers are used in a megabass mode, distortion is likely to take place. As a result, the sound cannot be widely broadcast to achieve a good listening quality.

### SUMMARY OF THE INVENTION

It is therefore a primary object of the present invention to provide an array speaker structure with pop-up mechanisms. The array speaker structure includes an array speaker unit, which can be bounced out under elastic restoring force of the pop-up mechanisms. Then the array speaker unit can be rotated to a front side of an audio/video device, whereby the speakers can emit sound from the front side of the audio/video device.

To achieve the above and other objects, the array speaker structure with pop-up mechanisms of the present invention includes: an array speaker unit; a first conductive connector; a second conductive connector, the array speaker unit being rotatably electrical-signal connected between the first and second conductive connectors; two pop-up mechanism, each pop-up mechanism including a slide block slidable within the slide passages of the first and second conductive connectors, a first spring being disposed in the slide block; and a pushbutton switch having a claw section for hooking the tooth sections of the first conductive connector with the first spring retracted in the slide block in a compressed state. When an external force is applied to the pushbutton switch, the claw section is moved away from the tooth sections, whereby the array speaker unit is bounced out under elastic restoring force of the first springs and can be then rotated to a desired position.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIG. 1 is a perspective assembled view of the present invention;

FIG. 2 is a perspective partially exploded view of the present invention;

FIG. 3 is a perspective exploded view of the present invention;

FIG. 4 is a perspective assembled view of the first conductive connector of the present invention;

FIG. 5 is a perspective exploded view of the first conductive connector of the present invention, showing that the conductive plate is separated from the first casing of the first conductive connector;

FIG. 6 is a perspective assembled view of the second conductive connector of the present invention;

FIG. 7 is a perspective exploded view of the second conductive connector of the present invention, showing that the conductive plate is separated from the first casing of the second conductive connector;

FIG. 8 is a perspective exploded view of the pop-up mechanism of the present invention;

FIG. 9 is a perspective view showing that the array speaker unit of the present invention is bounced out;

FIG. 10 is a perspective partially exploded view according to FIG. 9;

FIGS. 11, 12 and 13 show that the array speaker structure with pop-up mechanisms of the present invention is applied to an audio/video device, also showing the positional relationship between the claw section and the array speaker unit in a retracted state and a pop-up state; and

FIG. 14 is a perspective view showing that the array speaker unit of the present invention is bounced out and rotated to front side of the audio/video device.

### DETAILED DESCRIPTION OF THE PREFERRED EMBODIMENT

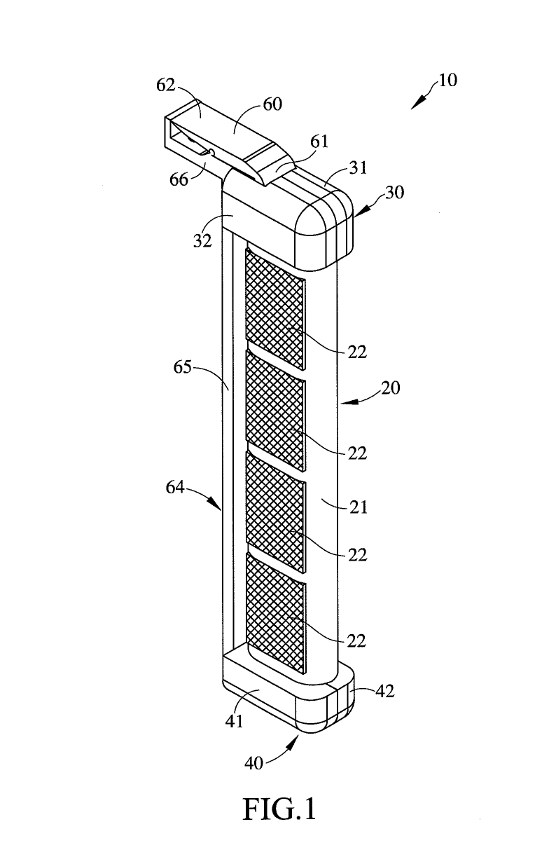

Please refer to FIGS. 1 to 3. The array speaker structure 10 with pop-up mechanisms of the present invention includes an array speaker unit 20, a first conductive connector 30, a second conductive connector 40, two pop-up mechanisms 50 and a pushbutton switch 60. The array speaker unit 20 includes a speaker box 21 and multiple speakers 22 installed in the speaker box 21. As shown in the drawings, in this embodiment, there are four speakers 22 are installed in the speaker box 21 in array. A metal head 23, 24 is installed at each of upper and lower end sections of the speaker box 21. The metal heads 23, 24 are electrical-signal (positive and negative electrodes) connected to the four speakers 22.

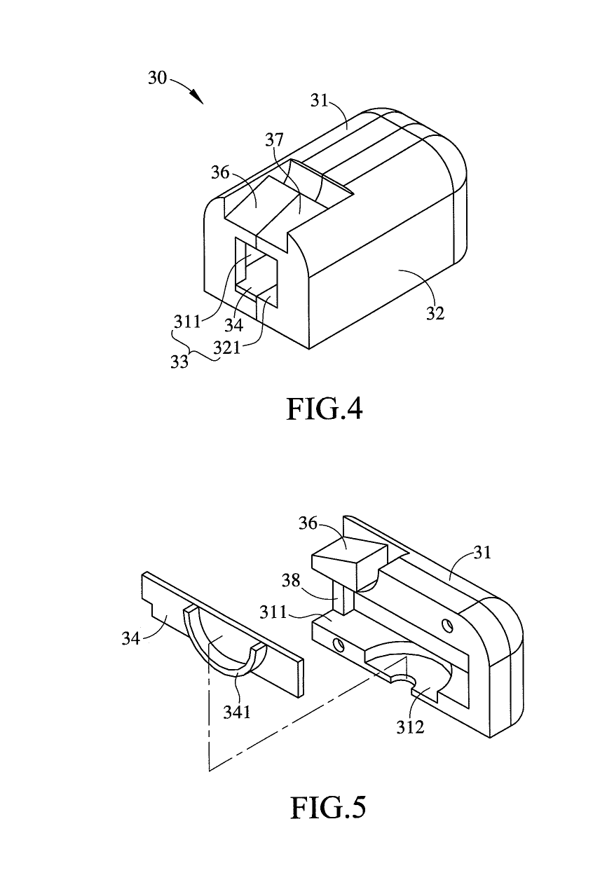

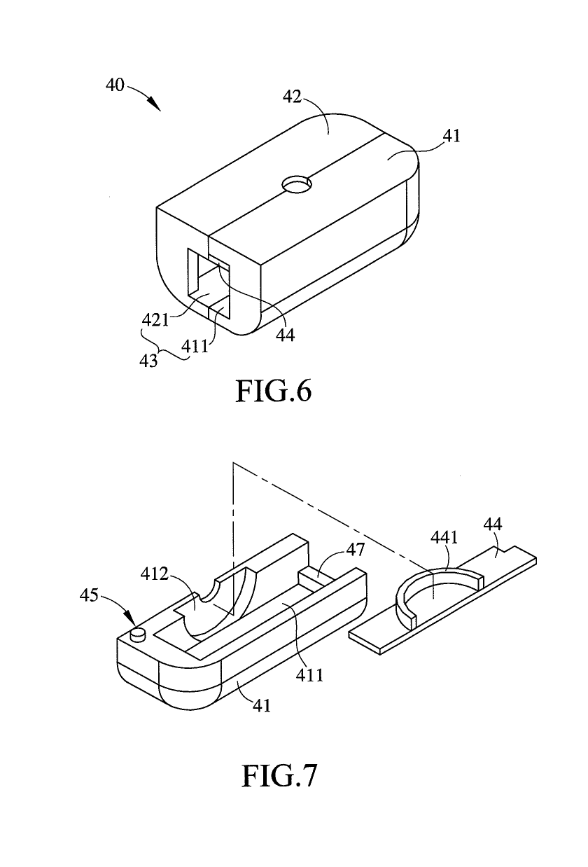

The first conductive connector 30 is connected to the upper end section of the array speaker unit 20, including a first casing 31 formed with an internal channel 311 and a second casing 32 formed with an internal channel 321. The channels 311, 321 together form a slide passage 33 as shown in FIG. 4. Inner sides of the bottom sections of the first and second casings 31, 32 are respectively formed with arched dents 312, 322. The arched dents 312, 322 together form a circular cavity. As shown in FIG. 5, the arched dent 312 communicates with the channel 311 of the first casing 31. A conductive plate 34 is positioned in the channel 311 and rested on an upper side of the arched dent 312 of the first casing 31. An arched contact 341 extends from a lower side of the conductive plate 34 and is positioned in the arched dent 312. The metal head 23 is received in the circular cavity formed of the arched dents 312, 322 in electrical-signal contact with the arched contact 341. The first and second casings 31, 32 are integrally connected to each other by means of insertion pin structure 35. Tooth sections 36, 37 are disposed at rear end sections of the first and second casings 31, 32. Stop plates 38, 39 extend from the bottoms of the tooth sections 36, 37 and are positioned at rear end openings of the channels 311, 321.

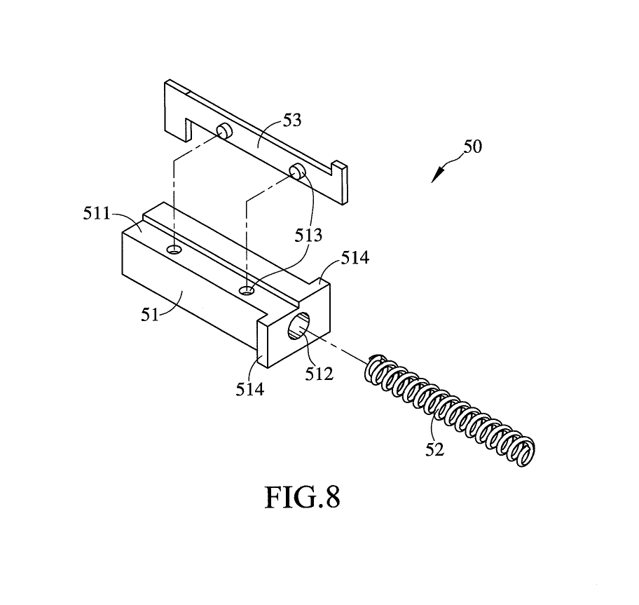

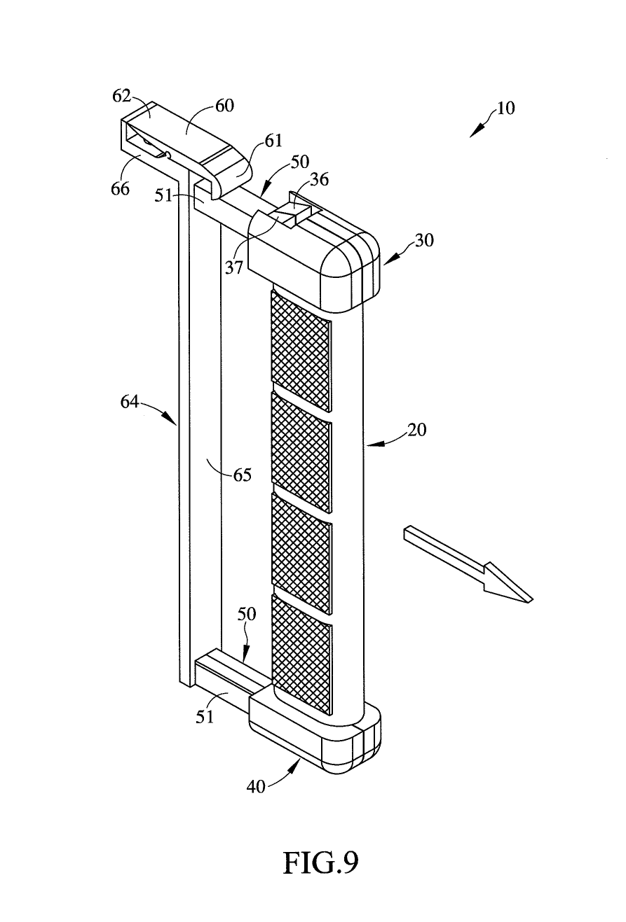

The second conductive connector 40 is connected to the lower end section of the array speaker unit 20 and arranged in the same direction as the first conductive connector 30. The second conductive connector 40 includes a first casing 41 formed with an internal channel 411 and a second casing 42 formed with an internal channel 421. The channels 411, 421 together form a slide passage 43 as shown in FIG. 6. Inner sides of the top sections of the first and second casings 41, 42 are respectively formed with arched dents 412, 422. The arched dents 412, 422 together form a circular cavity. As shown in FIG. 7, the channel 411 of the first casing 41 communicates with the arched dent 412. A conductive plate 44 is positioned in the channel 411 and rested on a lower side of the arched dent 412 of the first casing 41. An arched contact 441 extends from an upper side of the conductive plate 44 and is positioned in the arched dent 412. The metal head 24 is received in the circular cavity formed of the arched dents 412, 422 in electrical-signal contact with the arched contact 441. Stop plates 46, 47 are disposed at rear end openings of the channels 411, 421. The first and second casings 41, 42 are integrally connected to each other by means of insertion pin structure 45. In practice, the array speaker unit 20 is rotatably connected between the first and second conductive connectors 30, 40.

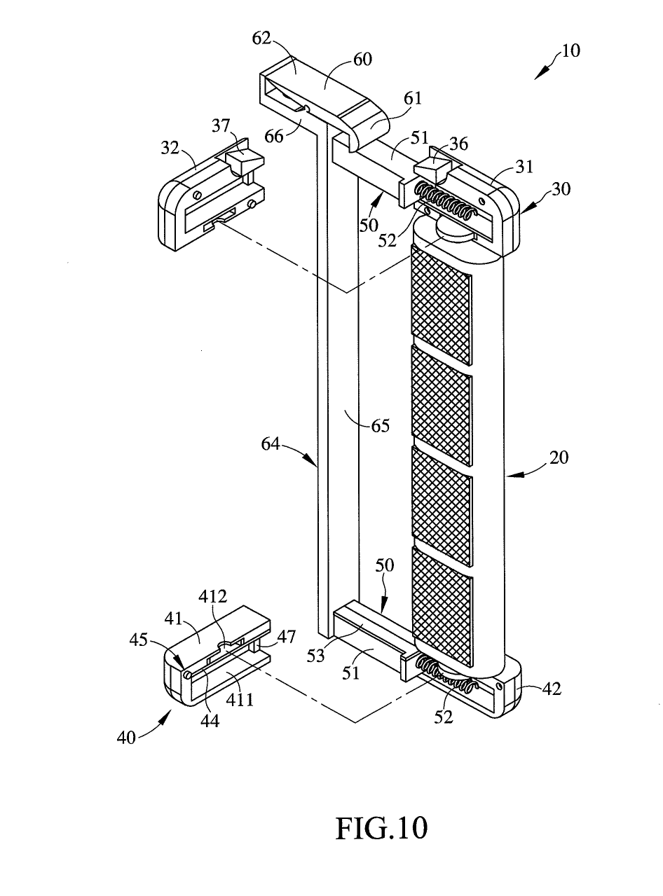

Each pop-up mechanism 50 includes a slide block 51 slidable within the slide passages 33, 43 of the first and second conductive connectors 30, 40. As shown in FIG. 8, a top section of the slide block 51 is formed with a stepped section 511. A first spring 52 is received in a receiving hole 512 of the slide block 51. A metal plate 53 is affixed to the stepped section 511 of the slide block 51. The metal plate 53 can be fixedly connected to the slide block 51 by means of recessed/raised structures 513 or the like engagement structures. The metal plates 53 are in electrical contact with the conductive plates 34, 44 respectively. Two abutment sections 514 are respectively disposed on two sides of front end of each slide block 51. The abutment sections 514 are positioned in the channels 311, 411 and stopped by the stop plates 38, 39, 46, 47, whereby the slide blocks 51 are prevented from being extracted out of the slide passages 33, 43 of the first and second conductive connectors 30, 40.

The pushbutton switch 60 has a claw section 61 at front end for hooking the tooth sections 36, 37 of the first conductive connector 30 and a press section 62 at rear end of the pushbutton switch 60. In practice, the press section 62 can be restored to its home position by means of a second spring 63.

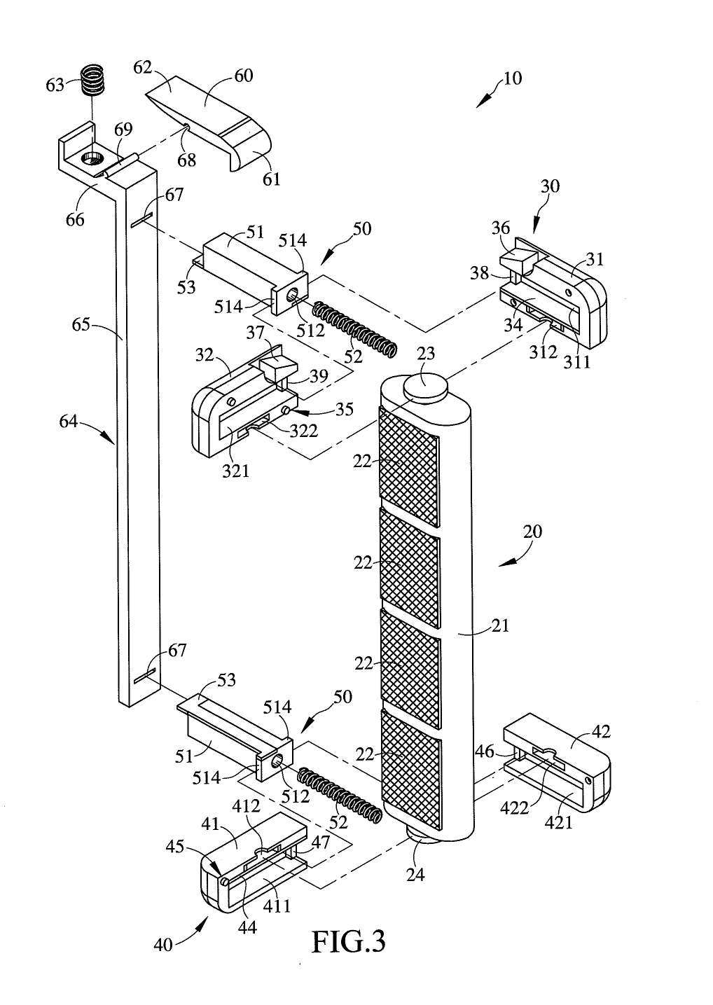

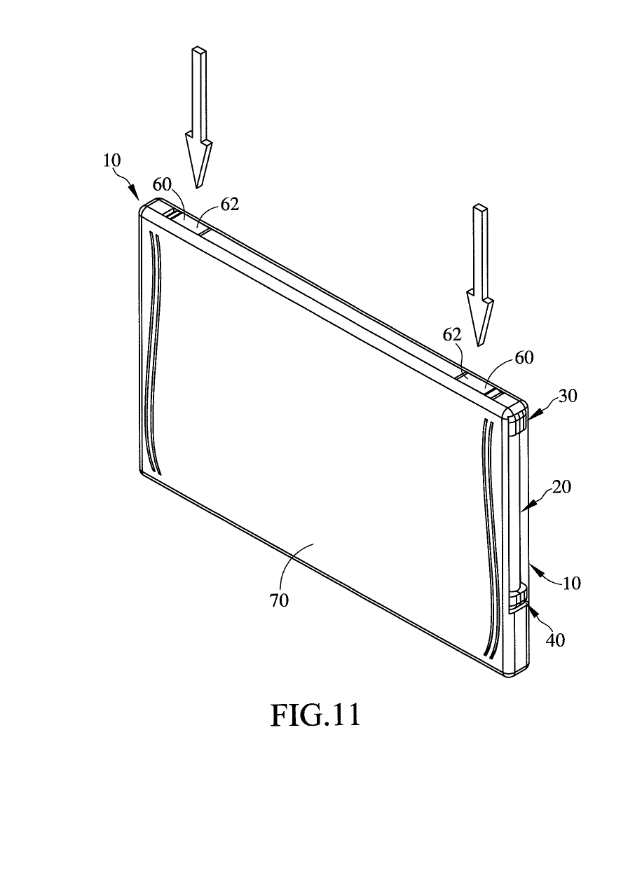

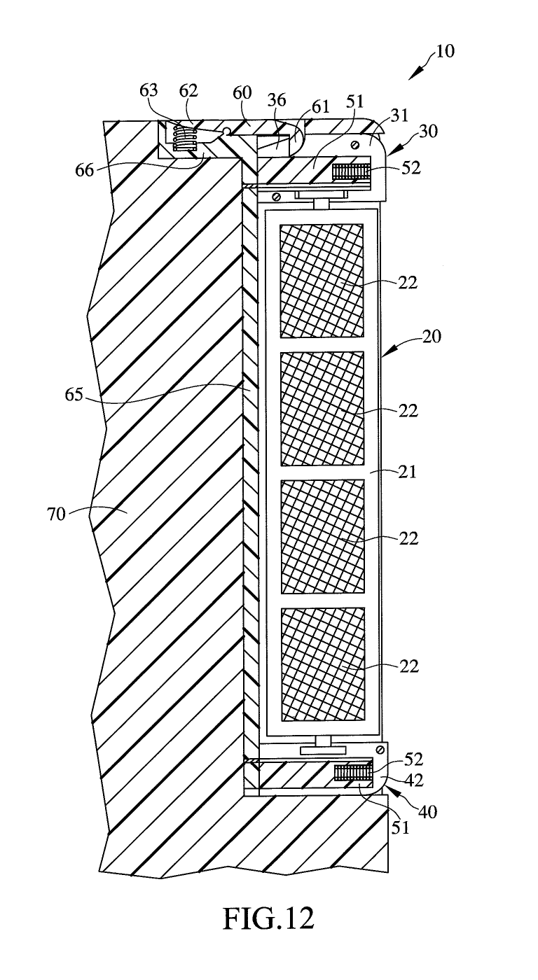

The pushbutton switch 60 further includes a fixing seat 64. The fixing seat 64 has a vertical section 65 and a horizontal section 66. The upper and lower ends of the vertical section 65 are formed with connection slits 67. The metal plates 53 are respectively fixed in the connection slits 67, whereby the two pop-up mechanisms 50 are connected to the fixing seat 64. As shown in FIG. 3, a bottom section of the pushbutton switch 60 is formed with an insertion groove 68. The horizontal section 65 has a fulcrum 69, which is inserted into the insertion groove 68 of the pushbutton switch 60. Accordingly, the pushbutton switch 60 can be shifted around the fulcrum 69 with the second spring 63 compressed between the press section 62 and the horizontal section 65. When the claw section 61 is moved away from the tooth sections 36, 37, the array speaker unit 20 will bounce out under the elastic restoring force of the first springs 52 as shown in FIGS. 9 and 10.

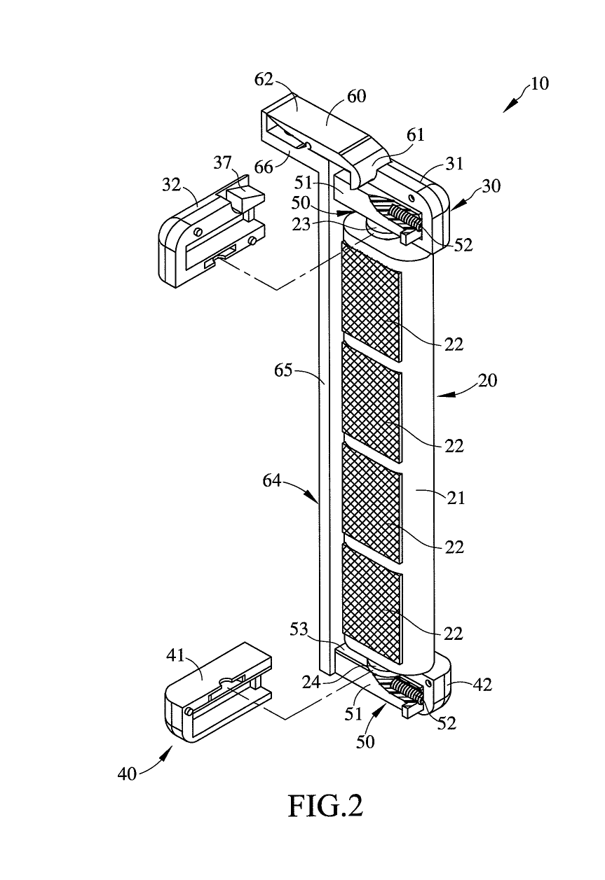

Referring to FIG. 2, when the claw section 61 hooks the tooth sections 36, 37, the first and second conductive connectors 30, 40 press the first springs 52 to retract into the receiving holes 512 of the slide blocks 51 in a compressed state. As shown in FIG. 10, when the claw section 61 is lifted, the first springs 52 are decompressed to apply an elastic restoring force to the first and second conductive connectors 30, 40, which drive the array speaker unit 20 to bounce out.

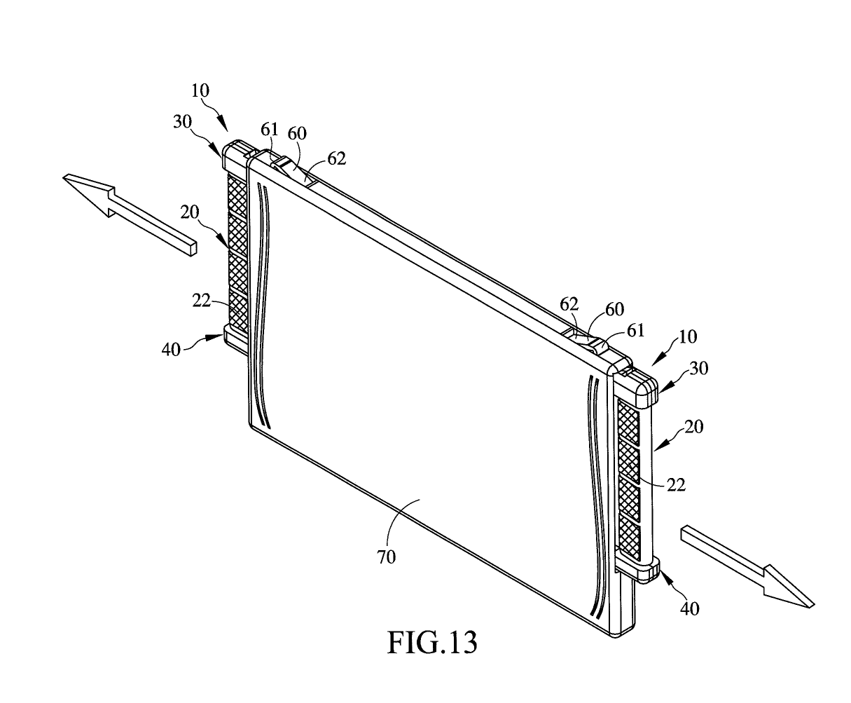

FIGS. 11, 12, 13 and 14 show that the array speaker structure 10 with pop-up mechanisms of the present invention is applied to an audio/video device such as a tablet 70, also showing the positional relationship between the claw section 61 and the array speaker unit 20 in a retracted state and a pop-up state. The array speaker structure 10 with pop-up mechanisms is inlaid in each of two sides of the tablet 70 with the claw section 61 hooking the tooth sections 36, 37. Under such circumstance, the array speaker unit 20 is positioned in a retracted position. In this mode, the speakers 22 are positioned on a backside of the tablet 70 to emit sound from the backside of the tablet 70 as shown in FIGS. 11 and 12.

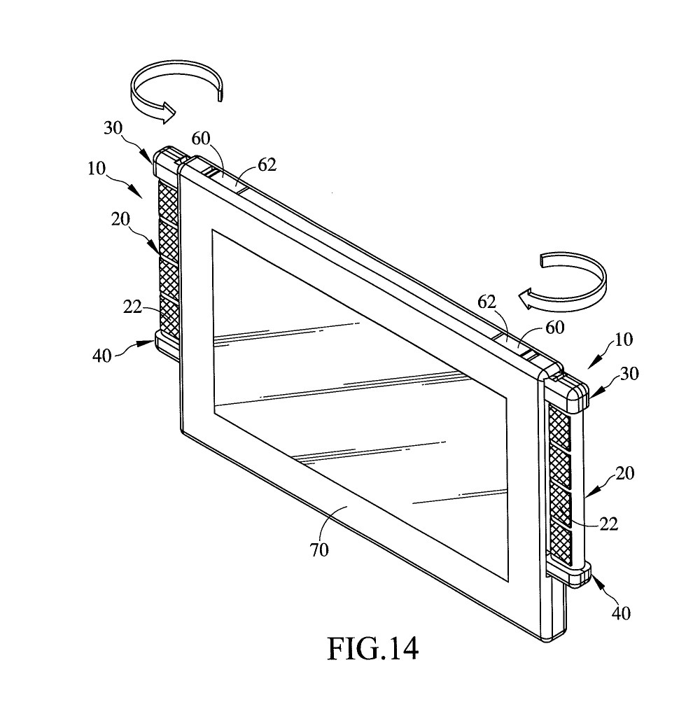

In an audio/video multimedia mode, a user can press down the press section 62 of the pushbutton switch 60 to release the first and second conductive connectors 30, 40. In this case, the array speaker unit 20 can bounce out under the elastic restoring force of the first springs 52 as shown in FIGS. 10 and 13. Then the array speaker unit 20 can be rotated to front side of the tablet 70, whereby the speakers 22 can emit sound from the front side of the tablet 70 as shown in FIG. 14.

In conclusion, by means of the pop-up mechanisms 50, the array speaker unit 20 of the present invention can be bounced out and rotated to the front side. In this case, the speakers can emit sound right toward a user. Each array speaker unit is composed of four speakers and there is an array speaker unit on either side. Therefore, the sound can be more widely broadcast to achieve better listening quality. Also, the left and right channels can provide a surrounding stereo sound effect for a user.

The present invention has been described with the above preferred embodiment thereof and it is understood that many changes and modifications in the above embodiment can be carried out without departing from the scope and the spirit of the invention that is intended to be limited only by the appended claims.

What is claimed is:

1. An array speaker structure with pop-up mechanisms, which is installed on two sides of an audio/video device, the array speaker structure comprising:
an array speaker unit;
a first conductive connector electrical-signal connected to an upper end section of the array speaker unit, the first conductive connector including a housing formed with an internal slide passage, a pair of tooth sections being formed at a rear end section of the housing;
a second conductive connector electrical-signal connected to a lower end section of the array speaker unit, the second conductive connector including a housing formed with an internal slide passage, the array speaker unit being rotatably connected between the first and second conductive connectors;
two pop-up mechanism correspondingly installed in the first and second conductive connectors in electrical contact therewith, each pop-up mechanism including a slide block slidable within the slide passages of the first and second conductive connectors, a first spring being disposed in the slide block; and
a pushbutton switch having a claw section for hooking the tooth sections of the first conductive connector with the first spring retracted in the slide block in a compressed state, when an external force is applied to the pushbutton switch, the claw section being moved away from the tooth sections, whereby the array speaker unit is bounced out under elastic restoring force of the first springs and can be then rotated to a front face of the audio/video device.

2. The array speaker structure with pop-up mechanisms as claimed in claim 1, wherein the array speaker unit includes a speaker box and multiple speakers installed in the speaker box in array, two metal heads being respectively connected to upper and lower end sections of the speaker box and electrical-signal-connected to the multiple speakers.

3. The array speaker structure with pop-up mechanisms as claimed in claim 2, wherein each of the first and second conductive connectors further includes a conductive plate positioned in the slide passage of the housing, the conductive plate having an arched contact extending from the conductive plate in electrical-signal contact with the metal head.

4. The array speaker structure with pop-up mechanisms as claimed in claim 3, wherein each pop-up mechanism further includes a metal plate mounted on the slide block, the metal plates being respectively electrical-signal connected to the conductive plates of the first and second conductive connectors.

5. The array speaker structure with pop-up mechanisms as claimed in claim 1, wherein the pushbutton switch further includes a fixing seat connected to two sides of the audio-video device, the fixing seat having a vertical section for fixing the pop-up mechanisms and a horizontal section on which the pushbutton switch is installed, whereby the pushbutton switch can be moved toward or away from the tooth sections of the first conductive connector.

6. The array speaker structure with pop-up mechanisms as claimed in claim 5, wherein a second spring is installed between a press section of the pushbutton switch and the horizontal section for restoring the press section to its home position.
